(19) United States
(12) Patent Application Publication
(10) Pub. No.: US 2025/0146533 A1
(43) Pub. Date: May 8, 2025

(54) BEARING SEAL ASSEMBLIES AND CONVEYOR SYSTEMS INCLUDING THE SAME

(71) Applicant: Cambelt International LLC, Salt Lake City, UT (US)

(72) Inventor: Venny Williams, Salt Lake City, UT (US)

(21) Appl. No.: 18/937,424

(22) Filed: Nov. 5, 2024

Related U.S. Application Data
(60) Provisional application No. 63/596,364, filed on Nov. 6, 2023.

(51) Int. Cl. F16C 35/04; F16C 33/76

(52) U.S. Cl. CPC F16C 35/045; F16C 33/768; F16C 2326/58

(57) ABSTRACT

An example bearing seal assembly includes a bearing mount defining a first passageway extending therethrough. The bearing seal assembly also includes at least one seal configured to be positioned in the first passageway. The bearing seal assembly further includes a retainer plate configured to be positioned adjacent to the bearing mount and to maintain the seal in the first passageway. The retainer plate defines a second passageway extending therethrough. The bearing seal assembly additionally includes a bearing apparatus configured to be positioned adjacent to the retainer plate. The first passageway, the second passageway, and the bearing apparatus are configured to receive a shaft.

### CROSS-REFERENCE TO RELATED APPLICATIONS

This claims priority of U.S. Provisional Patent Application No. 63/596,364, filed Nov. 6, 2023. The contents of the above-identified application are hereby incorporated herein, in its entireties, by reference.

### BACKGROUND

Many systems use bearing apparatuses. An example of such a system includes a conveyor belt. The bearing apparatus of the conveyor belt may be rotatably attached to a shaft and a belt may be disposed around the shaft.

During use, a material may be disposed on and removed from the belt. As such, the conveyor belt may be an at least partially open system thereby allowing the material to be disposed on and removed from the belt.

### SUMMARY

Embodiments disclosed herein related to bearing seal assemblies and conveyor systems including the same. In an embodiment, a bearing seal assembly is disclosed. The bearing seal assembly includes a bearing mount including a bottom plate, a top plate, and a bearing mount spacer positioned between the bottom plate and the top plate. The bottom plate is attached to the bearing mount spacer and the bearing mount spacer is attached to the top plate. The bearing mount defines a first passageway extending therethrough. The bearing seal assembly also includes at least one seal configured to be positioned in the first passageway and a retainer plate configured to be positioned adjacent to the top plate of the bearing mount. The retainer plate is configured to maintain the at least one seal in the first passageway. The retainer plate defines a second passageway extending therethrough. The bearing seal assembly additional includes a bearing apparatus configured to be positioned adjacent to the retainer plate. The first passageway, the second passageway, and the bearing assembly are configured to receive a shaft.

In an embodiment, a conveyor system is disclosed. The conveyor system includes a housing defining an interior region and at least one inlet configured to allow a material to enter the interior region. The conveyor system also includes a conveyor belt at least partially positioned in the interior region and a shaft partially positioned in the interior region. The conveyor belt is positioned around a portion of the shaft. The conveyor system additionally includes at least one bearing seal assembly attached to an exterior of the housing. The at least one bearing seal assembly includes a bearing mount including a bottom plate, a top plate, and a bearing mount spacer positioned between the bottom plate and the top plate. The bottom plate is attached to the bearing mount spacer and the bearing mount spacer is attached to the top plate. The bearing mount defines a first passageway extending therethrough. The bearing seal assembly also includes at least one seal positioned in the first passageway and a retainer plate positioned adjacent to the top plate of the bearing mount. The retainer plate is configured to maintain the at least one seal in the first passageway. The retainer plate defines a second passageway extending therethrough. The bearing seal assembly also includes a bearing apparatus positioned adjacent to the retainer plate. The first passageway, the second passageway, and the bearing assembly are receive the shaft.

In an embodiment, a method of using a bearing seal assembly is disclosed. The method includes rotating a shaft extending through a first passageway of a mounting plate, a second passageway of a retainer plate, and attached to a bearing apparatus. The bearing seal assembly includes the mounting plate. The mounting plate includes a bottom plate, a top plate, and a bearing mount spacer positioned between the bottom plate and the top plate. The bottom plate is attached to the bearing mount spacer and the bearing mount spacer is attached to the top plate. The bearing mounting plate defines the first passageway extending therethrough. The bearing seal assembly includes at least one seal configured to be positioned in the first passageway and the retainer plate positioned adjacent to the top plate of the bearing mount. The retainer plate is configured to maintain the at least one seal in the first passageway. The retainer plate defines the second passageway extending therethrough. The bearing apparatus is positioned adjacent to the retainer plate.

In an embodiment, a method to repair a bearing seal assembly is disclosed. The method includes detaching a bearing apparatus from a retainer plate and a bearing mount and repairing or replacing one or more components of the bearing seal assembly. The bearing seal assembly includes a mounting plate. The mounting plate includes a bottom plate, a top plate, and a bearing mount spacer positioned between the bottom plate and the top plate. The bottom plate is attached to the bearing mount spacer and the bearing mount spacer is attached to the top plate. The bearing mounting plate defines a first passageway extending therethrough. The bearing seal assembly includes at least one seal configured to be positioned in the first passageway and a retainer plate positioned adjacent to the top plate of the bearing mount. The retainer plate is configured to maintain the at least one seal in the first passageway. The retainer plate defines a second passageway extending therethrough. The bearing apparatus is positioned adjacent to the retainer plate before detaching the bearing apparatus from the retainer plate and the bearing mount.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1A is an isometric view of a bearing seal assembly, according to an embodiment.

FIG. 1B is a cross-sectional view of the bearing seal assembly taken along plane 1B-1B when the bearing seal assembly is attached to a housing.

FIG. 1C is an exploded view of the bearing seal assembly.

FIG. 2A is an isometric view of a bearing seal assembly that includes at least one apparatus spacer, according to an embodiment.

FIG. 2B is a cross-sectional view of the bearing seal assembly taken along plane 2B-2B and FIG. 2C is an exploded view of the bearing seal assembly.

FIG. 3 is an isometric view of the closed bulk material conveyor system that includes one or more bearing seal assemblies, according to an embodiment.

### DETAILED DESCRIPTION

Embodiments disclosed herein related to bearing seal assemblies and conveyor systems including the same. An example bearing seal assembly includes a bearing mount defining a first passageway extending therethrough. The bearing seal assembly also includes at least one seal configured to be positioned in the first passageway. The bearing seal assembly further includes a retainer plate configured to be positioned adjacent to the bearing mount and to maintain the seal in the first passageway. The retainer plate defines a second passageway extending therethrough. The bearing seal assembly additionally includes a bearing apparatus configured to be positioned adjacent to the retainer plate. The first passageway, the second passageway, and the bearing apparatus are configured to receive a shaft.

The bearing seal assembly may form part of conveyor system. For example, the bearing mount may be attached to the housing of a conveyor system. The seal may be disposed in the first passageway and the retainer plate may be attached to the bearing mount thereby securing the seal in the first passageway. The bearing apparatus may be further attached to the retainer plate. A shaft of the conveyor system may be positioned through the first passageway and the second passageway. The shaft may be attached to the bearing apparatus. When the shaft is positioned through the first passageway, the seal may press against or otherwise seal against the shaft thereby preventing or at least inhibiting a material (e.g., bulk material or other material received by the conveyor system) from moving along the shaft.

In an embodiment, the conveyor system is a closed conveyor system. In such an embodiment, the housing of the closed conveyor belt defines an interior region and an inlet that allows a material to enter the interior region. The conveyor system further includes a conveyor belt extending around a portion of the shaft. During use, the material may be disposed in the interior region via the inlet. The conveyor belt may move the material from the inlet towards an outlet defined by the housing. The bearing seal assembly protects the bearing apparatus by preventing or at least inhibiting the material from reaching the bearing apparatus thereby increasing a life span of the bearing apparatus.

The bearing seal assemblies disclosed herein are an improvement over the conventional bearing assemblies, such as conventional bearing assemblies commonly used in closed conveyor systems. For example, at least some conventional bearing assemblies are unable to prevent or significantly inhibit the material from moving along the shaft to the bearing apparatus. The material that reaches the bearing apparatus may damage, ruin, or otherwise adversely affect the operation of the bearing apparatus thereby necessitating the repair or replacement of the bearing apparatus. Such repair or replacement of the bearing apparatus requires shutting down the closed conveyor system for a time. However, the bearing seal assemblies disclosed herein are able to prevent or at least inhibits movement of the material or other material along the shaft. For example, as previously discussed, the bearing seal assemblies disclosed herein include a seal that prevents or inhibits flow of the material along the shaft. As will be discussed in more detail below, the bearing seal assemblies disclosed herein may include other features in addition or instead of the seal that prevents or inhibits the material from moving along the shaft. As such, the bearing seal assemblies disclosed herein prevent or significantly inhibit the material from reaching the bearing apparatus, thereby allowing the bearing apparatus of the bearing seal assemblies disclosed herein to operate longer than the bearing apparatuses of conventional bearing assemblies without needing to be repaired or replaced.

In some embodiments, the bulk material flowing through the interior region of the close conveyor system may be heated. It has been found that the thermal energy from the heated bulk material may flow along the shaft and reached the bearing apparatus of the conventional bearing assembly. This thermal energy significantly decreases the life span of the bearing apparatus of the conventional bearing assemblies. For example, it has been found that the bearing assemblies that are expected to have a life span of a year or more may fail after a few days of use when the closed conveyor system receives the heated bulk material. However, the bearing seal systems disclosed herein at least partially isolate the bearing apparatuses thereof from the thermal energy of the heated bulk material for one or more reasons. For example, at least the bearing mount and the retainer plate space the bearing apparatus further from the housing of the closed conveyor system than at least some conventional bearing assemblies which allows some of the thermal energy to dissipate before reaching the bearing apparatus. Further, the bearing mount and the retainer plate, along with other optional features of the bearing seal assemblies disclosed herein, act as heat sinks that pull thermal energy from the shaft before the thermal energy may reach the bearing apparatus. The bearing seal assemblies disclosed herein may also include one or more features that facilitate cooling of the shaft and form barriers to the thermal energy flowing from the heated bulk material to the bearing apparatus. These features include, for instance, the seal and the optional apparatus spacers that will be discussed in more detail below.

The bearing seal assemblies disclosed herein may be also easier to repair and replace (when needed) compared to at least some conventional bearing assemblies. For example the repair and/or replacement of the conventional bearing assemblies may require detaching the entire conventional bearing assembly from the housing of the closed conveyor system. The conveyor belt may need to have the tension thereof decreased before the conventional bearing assembly may be detached from the housing and then have the tension thereof increased when reattaching the conventional bearing assembly to the housing, both of which may be a time-consuming process. Further, the shaft may shift in the housing when the conventional bearing assembly is detached from the housing which may damage the shaft and may complicate reattaching the conventional bearing assembly to the housing. The bearing seal assemblies disclosed herein do not need to be entirely detached from the housing of the closed conveyor system when one or more parts of the bearing seal assembly need to be repaired or replaced. For example, the bearing mount may remain attached to the housing when the bearing apparatus and/or the seal need to be repaired or replaced. The bearing mount may support the shaft during such replacement and repair such that conveyor belt does not need to have the tension thereof decreased and the shaft, at most, negligibly moves in the housing.

The bearing seal assemblies disclosed herein may be especially beneficial when used with close conveyor systems, as discussed above. That said, the bearing seal assemblies disclosed herein may be used with other types of conveyor systems or any system that uses bearing assemblies. The bearing seal systems disclosed herein may still have one or more of the above benefits and/or any of the other benefits disclosed herein when used with other types of conveyor systems or another system that uses bearing assemblies.

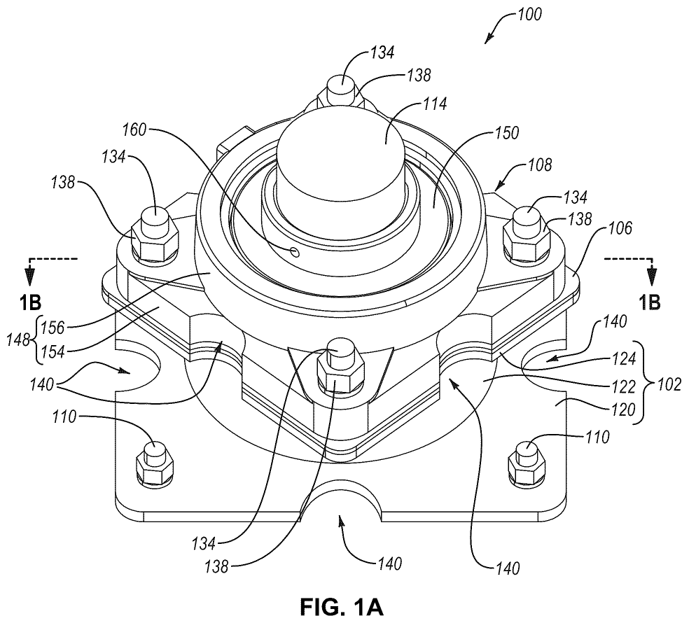

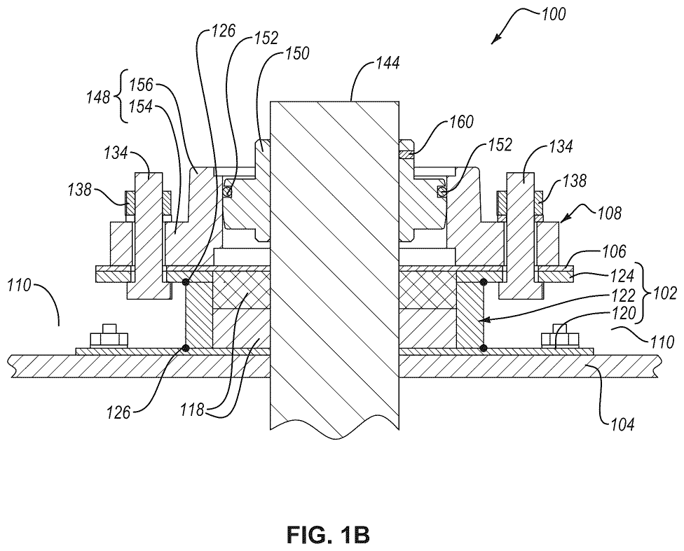

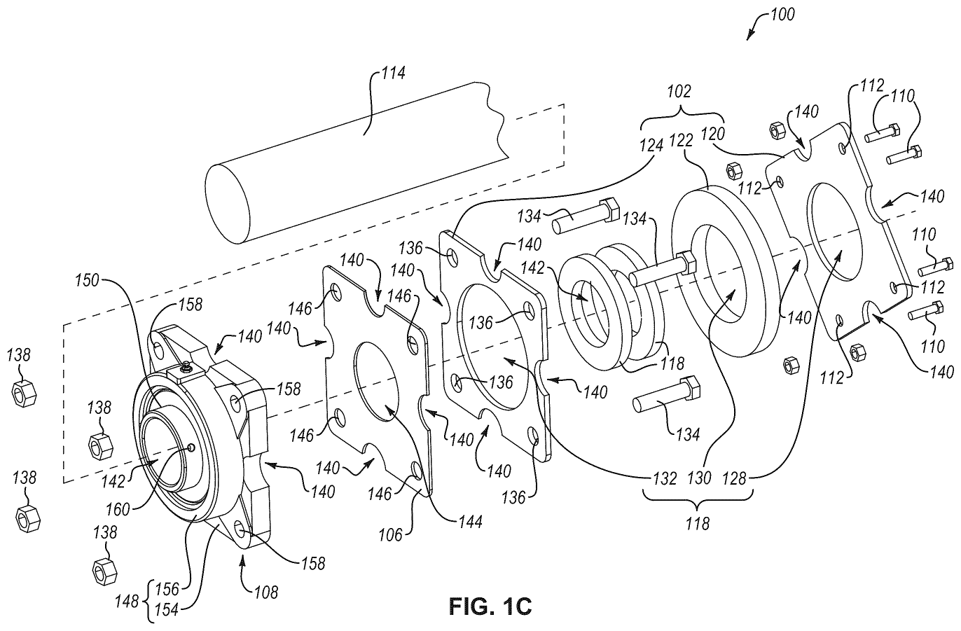

FIG. 1A is an isometric view of a bearing seal assembly 100, according to an embodiment. FIG. 1B is a cross-sectional view of the bearing seal assembly 100 taken along plane 1B-1B when the bearing seal assembly 100 is attached to a housing 104. FIG. 1C is an exploded view of the bearing seal assembly 100. As shown, the bearing seal assembly 100 includes a bearing mount 102 configured to be attached to the housing 104. The bearing seal assembly 100 also includes a retainer plate 106 configured to be positioned adjacent to the bearing mount 102 and a bearing apparatus 108 configured to be positioned adjacent to the retainer plate 106.

As previously discussed, the bearing mount 102 may be attached to the housing 104. In an embodiment, as shown, the bearing mount 102 may be attached to the housing 104 using a plurality of first bolts 110. In such an embodiment, the portion of the bearing mount 102 that is configured to be attached to the housing 104 (e.g., the bottom plate 120) may define one or more first bolt holes 112 that are configured to receive the first bolts 110. The housing 104 may likewise define one or more bolt holes (not labeled, occupied) that are configured to receive the first bolts 110. Attaching the bearing mount 102 to the housing 104 using the first bolts 110 allows the bearing mount 102 to be easily and reversibly attached to the housing 104, such as when the bearing mount 102 needs to be replaced or repaired. It is noted that, generally, the bearing mount 102 is less likely to fail or otherwise need repair or replacement compared to other components of the bearing seal assembly 100. However, the bearing mount 102 may need to be replaced or repaired when the closed conveyor system received an abrasive material since one or more surfaces of the bearing mount 102 may come in contact with the abrasive bulk material which may cause wear on the bearing mount 102, the shaft 114 may contact the bearing mount 102 causing wear thereon, or the shaft 114 may be replaced with another sized shaft which may require swapping the entire bearing seal assembly 100 with another bearing seal assembly 100. In an embodiment, the bearing mount 102 may be attached to the housing 104 using non-bolt techniques instead of or in addition to the first bolts 110. Examples of such non-bolt techniques includes using clamps, screws, welds, solder, rivets, an adhesive, or any other suitable technique.

The bearing mount defines a first passageway 116 extending therethrough. For example, the first passageway 116 may extend from a back surface of the bearing mount 102 that is adjacent to (e.g., abuts) the housing 104 (e.g., an outermost surface of the bottom plate 120) to a front surface that is adjacent to the retainer plate 106 (e.g., an opposing surface of the top plate 124) when the bearing seal assembly 100 is assembled. The first passageway 116 is configured to receive the shaft 114. The first passageway 116 may also be configured to receive additional components of the bearing seal assembly 100, such as the at least one seal 118. As will be discussed in more detail below, the ability of the first passageway 116 to receive additional components may cause a lateral dimension (e.g., diameter, maximum lateral dimension, etc.) of the first passageway 116 to vary.

In an embodiment, the bearing mount 102 may be formed from a plurality of components that are attached together. For example, the bearing mount 102 may be formed from a bottom plate 120, a bearing mount spacer 122, and a top plate 124. Forming the bearing mount 102 from a plurality of components may facilitate manufacturing of the bearing mount 102. For example, as previously discussed, a lateral dimension of the first passageway 116 may vary. At least two of the plurality of components that forms the bearing mount 102 may define openings exhibiting different lateral dimensions, such as plates and/or hollow cylinders defining openings with different lateral dimensions. The first passageway 116 exhibiting different lateral dimensions is simply formed by attaching the components together. The different components may be attached together using any suitable technique, such as welds 126 (illustrated schematically in FIG. 1B as dots), clamps, screws, solder, bolts, rivets, or any other suitable technique. In an embodiment, the bearing mount 102 may be formed from a single piece. In such an embodiment, the first passageway 116 may need to be machined into the bearing mount 102 which may be difficult and time consuming if the lateral dimension of the first passageway 116 varies.

In an embodiment, as shown, the bearing mount 102 includes a bottom plate 120. The bottom plate 120 is configured to be attached to the housing 104. As such, the bottom plate 120 defines the first bolt holes 112. A surface of the bottom plate 102 that abuts the housing 104 may exhibit a topography that generally corresponds to the topography of the portion of the housing 104 to which the bottom plate 120 is attached thereby preventing or inhibiting a material in the interior region of the housing 104 from leaking between the housing 104 and the bottom plate 120. For example, a surface of the bottom plate 102 may exhibit a generally flat topography if the portion of the housing 104 that abuts the surface is also generally flat. Additionally or alternatively, the bearing seal assembly 100 may include a seal (e.g., O-ring, felt sheet, etc.) configured to be positioned between the housing 104 and the bottom plate 120 to prevent or inhibit the material leaking between the housing 104 and the bottom plate 120.

The bottom plate 120 may define a first portion 128 of the first passageway 116. The first portion 128 may exhibit a lateral dimension (e.g., diameter or maximum lateral dimension) that generally corresponds to a lateral dimension of the shaft 114. The similar lateral dimension of the first portion 128 relative to the shaft 114 may minimize the flow of the material between the shaft 114 and the bottom plate 120. The similar lateral dimension of the first portion 128 relative to the shaft 114 also allows the first portion 128 to support the shaft 114 when one or more other components of the bearing seal assembly 100 (e.g., the retainer plate 106, the bearing apparatus 108, or the seal 118) are removed for repair or replacement without allowing the shaft 114 to significantly shift. In an example, the first portion 128 may exhibit a lateral dimension that is slightly greater than (e.g., about 50 μm to about 1 mm or, more preferably 50 μm to about 500 μm greater than) the corresponding lateral dimension of the shaft 116. The slightly larger lateral dimension of the first portion 128 still minimizes flow of the material between the bottom plate 120 and the shaft 114 and supports the shaft 114 during repairs. However, the slightly larger lateral dimension of the first portion 128 prevents or at least inhibits contact between the shaft 114 and the bottom plate 120 during operation which may cause friction that impedes rotation of the shaft 114, minimizes heat generated in the bearing seal assembly 110 generated by such friction, and prevents undesired wear on the shaft 114 and the bottom plate 120.

The bearing mount 102 may include the bearing mount spacer 122. The bearing mount spacer 122 is attached to or otherwise configured to be positioned adjacent to the bottom plate 120, such as attached to or positioned adjacent to a surface of the bottom plate 120 opposite the surface of the bottom plate 120 that abuts the housing 104. The bearing mount spacer 122 may move the bearing apparatus 108 further from the housing 104 than if the bearing mount spacer 122 was omitted from the bearing mount 102 which may limit thermal energy from the interior region reaching the bearing apparatus 108 and decreases the likelihood that material from the interior region is able to reach the bearing apparatus 108.

The bearing mount spacer 122 defines a second portion 130 of the first passageway 116 that is configured to receive the shaft 114. In an embodiment, the second portion 130 of the first passageway 116 exhibits a lateral dimension (e.g., diameter or maximum lateral dimension) that is greater than a corresponding lateral dimension of the first portion 128. The larger lateral dimension of the second portion 130 of the first passageway 116 relative to the first portion 128 allows the second portion 130 to receive and support the seal 118 in the first passageway 116. The smaller lateral dimension of the first portion 128 of the first passageway 116 relative to the second portion 130 may prevent the seal 118 from moving towards and into the housing 104.

The bearing mount 102 may include the top plate 124. The top plate 124 is configured to be positioned adjacent to and/or attached to a side of the bearing mount spacer 122 opposite the bottom plate 120. The top plate 124 defines a third portion 132 of the first passageway 116. In an embodiment, the third portion 132 may exhibit a lateral dimension (e.g., diameter or maximum lateral dimension) and shape that generally corresponds to the lateral dimension and shape of the second portion 130 of the first passageway 116. In such an embodiment, the third portion 132 may receive the shaft 114 and may allow the seal 118 to be easily removed from the second portion 130. Also, the third portion 132 may receive and hold the seal 118 therein when the third portion 132 exhibits a size and shape that corresponds to the size and shape of second portion 130. In an embodiment, the third portion 132 may exhibit a lateral dimension that is greater than the corresponding lateral dimension of the second portion 130. The larger lateral dimension of the third portion 132 may facilitate inserting the seal 118 into the second portion 130, for example, when the third portion 132 is tapered. In an embodiment, the third portion 132 may exhibit a lateral dimension that is less than the corresponding lateral dimension of the second portion 130. In such an embodiment, the third portion 132 may help maintain the seal 118 in the second portion 130.

The top plate 124 may be configured to allow one or more components of the bearing seal assembly 100 (e.g., the retainer plate 106 and the bearing apparatus 108) to be attached to the bearing mount 102. In an example, the top plate 124 may be configured to be attached to one or more components of the bearing seal assembly 100 using one or more second bolts 134. In such an example, the top plate 124 may define one or more second bolt holes 136 that are configured to receive the second bolts 134. Attaching the top plate 124 to one or more components of the bearing seal assembly 100 with the second bolts 134 allows the components of the bearing seal assembly 100 to be easily detached from the bearing mount 102, for instance, when the retainer plate 106, the bearing apparatus 108, or the seal 118 need to be replaced or repaired. In particular, the nuts 138 that are attached to the second bolts 134 may be remove thereby allowing components to slide off the second bolts 134 to detach the components from the bearing mount 102. However, the shaft 118 may remain supported by the bearing mount 102 even as these additional components are detached. In a particular example, the second bolts 132 may exhibit a length that is greater than the length of the bearing mount spacer 122 and the bottom plate 120 (e.g., greater than a distance from the top plate 124 to the housing 104). In such an example, the second bolts 132 may remain attached to the top plate 124 after removing the nuts 138 therefrom when the head of the second bolt 132 is adjacent to the side of the top plate 124 that is closest to the housing 104. In other words, the second bolts 134 will not inadvertently fall off the bearing mount 102 during repair or replacement of one or more components of the bearing seal assembly 100, especially since the second bolts 134 falling off the bearing mount 102 may be difficult to recover (e.g., fall under a conveyor system). The top plate 124 may be attached to the one or more components of the bearing seal assembly 100 using other techniques, such as a clamps, screws, weld, solder, an adhesive, rivets, or any other suitable technique.

In an embodiment, the bottom plate 120 and the top plate 124 may extend outwardly from the bearing mount spacer 122. The portions of the bottom plate 120 and the bottom plate that extend outwardly from the bearing mount spacer 122 provide locations for the bottom plate 120 to be attached to the housing 104 and the top plate 124 to be attached to other components of the bearing seal assembly 100 without the bearing mount spacer 122 interfering with such attachments. For example, as illustrated, the portions of the bottom plate 120 and the top plate 124 that extend furthest from the bearing mount spacer 122 may include the first bolt holes 112 and the second bolt holes 136, respectively.

The bottom plate 120 may include one or more portions that are not positioned directly below the top plate 124. Similarly, the top plate 124 may include one or more portions that are not positioned directly above the bottom plate 120. The portions of the bottom plate 120 that are not below the top plate 124 and/or portions of the top plate 124 that are not above the bottom plate 120 may facilitate attachment of the bottom plate 120 to the housing 104 and the top plate 124 to the rest of the bearing seal assembly 100. For example, the portions of the bottom plate 120 that are not below the top plate 124 may allow the first bolts 110 to be inserted into the first bolt holes 112 without the top plate 124 restricting such placement of the first bolts 110. Similarly, the portion of the top plate 124 that are not above the bottom plate 120 may allow the second bolts 134 to be inserted into the second bolt holes 136 without the bottom plate 120 restricting such placement of the second bolts 134. In a particular example, the bottom plate 120 and the top plate 124 may be rotated from each other such that the portions of the bottom plate 120 that are attached to the housing 104 (e.g., the first bolt holes 112) are not below the portions of the top plate 124 that are attached to the rest of the bearing seal assembly 100 (e.g., the second bolt holes 136). For example, as illustrated, the bottom plate 120 and the top plate 124 exhibit a generally rectangular or square shape and the top plate 124 is rotated 45° relative to the bottom plate 120 such that an apex of the top plate 124 does not cover (e.g., is not positioned above) an apex of the bottom plate 120. Such rotation of the bottom plate 120 relative to the top plate 124 allows the first bolts 110 to be inserted into the first bolt holes 112 and the second bolts 134 to be inserted into the second bolt holes 136 when the bearing mount 102 is assembled (e.g., the bottom plate 120 is attached to the bearing mount spacer 122 and the bearing mount spacer 122 is attached to the top plate 124) and the first bolts 110 and the second bolts 136 exhibit a length that is greater than a thickness of the bearing mount spacer 122.

In an embodiment, the bottom plate 120 and/or the top plate 124 may define one or more cutouts 140. The cutouts 140 of the bottom plate 120 may be directly below the portions of the top plate 124 that are attached to the other components of the bearing seal assembly 100. For example, the cutouts 140 of the bottom plate 120 may be directly below the second bolt holes 136. The cutouts 140 of the top plate 124 may be directly above the portions of the bottom plate 120 that are attached to the housing 104. For example, the cutouts 140 of the top plate 124 may be directly above the first bolt holes 112. The cutouts 140 of the bottom plate 120 and/or the top plate 124 may facilitate attachment of the bearing mount 102 to the other components of the bearing seal assembly 100 and the housing 104. For instance, as illustrated, the cutouts 140 may facilitate insertion of the first bolts 110 into the first bolt holes 112 and the second bolts 134 into the second bolt holes 136 and using a ratchet to tighten the first bolts 110 and the second bolts 134, regardless if the bottom plate 120 is rotated relative to the top plate 124.

In an embodiment, one or more of the bottom plate 120, the bearing mount spacer 122, or the top plate 124 may be omitted from the bearing mount 102. For example, the top plate 124 may be omitted when the bearing mount spacer 122 is configured to have the other components of the bearing seal assembly 100 attached thereto. In an embodiment, the bearing mount 102 may include one or more elements instead of or in addition to one or more of the bottom plate 120, the bearing mount spacer 122, or the top plate 124. For example, the bearing mount 102 may include brackets that are configured to attach at least one of one or more components of the mount plate 102 together, attach the bearing mount 102 to the housing 102, or attach the bearing mount 102 to the other components of the bearing seal assembly 100.

As previously discussed, the bearing seal assembly 100 may include at least one seal 118. The seal 118 is configured to prevent or at least inhibit flow of the material from the interior chamber of the housing 104 through the bearing mount 102. The seal 118 may prevent or inhibit the flow of the material by at least partially occupying the space between the bearing mount 102 and the shaft 114. For example, the seal 118 may define a seal opening 142. The seal opening 142 may exhibit a lateral dimension (e.g., diameter or maximum lateral dimension) that is substantially equal to or, if the seal 118 is flexible or compressible, slightly smaller than the shaft 114. It is noted that the seal opening 142 exhibiting a lateral dimension that is slightly smaller than the shaft 114 may be preferable since the seal 118 presses against the shaft 114 which may minimizes the formation of any gaps between the shaft 114 and the seal 118 during operation (e.g., that may form due to different coefficients of thermal expansion) and allows the seal 118 to expand over time without decreasing the seal's 118 ability to seal against the shaft 114. The seal 118 may also exhibit a lateral dimension and shape that is the same as or, if the seal 118 is flexible or compressible, slightly larger than at least a portion of the first passageway 118 that received the seal 118 (e.g., the second portion 130). It is noted that the seal 118 exhibiting a lateral dimension and shape that is slightly larger than at least a portion of the first passageway 118 that receives the seal 118 allows the seal 118 to press against the bearing mount 102 and to accommodate small changes in the size of the bearing mount 102 and/or the seal 118 during operation, such as due to abrasive wear or different coefficients of thermal expansion.

The seal 118 may include any suitable type of seal. In an example, as shown, the seal 118 may include a felt seal. The felt seal may exhibit a relatively small coefficient of static and kinetic friction against the shaft 114 such that the felt seal only negligibly increases the energy required to rotate the shaft 114. The flexibility of the felt seal may also inhibit abrasive wear thereof by the material thereby increasing the lifespan of the seal 118. The flexibility and compressibility of the felt seal allows the seal opening 142 defined thereby to be smaller than the size of the shaft 114 and the size of the felt seal to be larger than the portion of the first passageway 116 that receives the seal 118. In an example, the seal 118 may include a seal other than or in addition to the felt seal. For instance, the seal 118 may include an O-ring (e.g., a greased O-ring to reduce friction), grease, other types of fabric, an abrasion resistant annular disk, any other suitable seal, or combinations thereof.

In an embodiment, the seal 118 may exhibit a length (measured parallel to the shaft 114) that is greater than the length of the second portion 130 and the third portion 132. In such an embodiment, the seal 118 may extend out of the first passageway 116. The seal 118 extending out of the first passageway 116 may allow the retainer plate 106 to press against the seal 118 when the retainer plate 106 is attached to the bearing mount 102. Pressing the retainer plate 106 against the seal 118 prevents or at least inhibits any material that reaches the retainer plate 106 from moving between the retainer plate 106 and the seal 118. In a particular embodiment, the seal 118 may be flexible and/or compressible. In such an embodiment, attaching the retainer plate 106 to the bearing mount 102 may deform the seal 118 when the length of the seal 118 causes the seal 118 to extend from the first passageway 116 which, in turn, may cause the seal 118 to at least partially fill any otherwise unoccupied space in the portions of the first passageway 116 that receive the seal 118.

In an embodiment, the seal 118 may include a single seal 118. In an embodiment, as shown, the seal 118 may include a plurality of seals. The seal 118 may include a plurality of seals for a variety of reasons. In an example, the material used to form the plurality of seals (e.g., O-rings or felt seal) may be commercially available exhibiting certain thicknesses or may be difficult to handle or cut when above a certain thickness. In such an example, forming the seal 118 from the plurality of seals allows the overall seal 118 to exhibit a thickness that is greater than if the seal 118 only included a single seal. The increased thickness may be beneficial since increasing the thickness of the seal 118 improves the ability of the seal 118 to prevent the material from moving along the shaft 114. In an example, the plurality of seals allows one or more seals to remain in contact with the shaft 114 when one or more other seals are removed or replaced. In an example, the plurality of seals allows the bearing seal assembly 100 to include a plurality of different seals, such as a greased O-ring and a felt seal, since some seals may prevent or inhibit flow of different types of material along the shaft 114 better than other seals.

As previously discussed, the bearing seal assembly 100 further includes a retainer plate 106. The retainer plate 106 defines a second passageway 144 extending therethrough. The second passageway 144 exhibits a lateral dimension (e.g., diameter or maximum lateral dimension) that is less than an adjacent lateral dimension of the second portion 130 of the first passageway 116. The smaller lateral dimension of the second passageway 144 relative to the adjacent lateral dimension of the second portion 130 may cause the retainer plate 106 to prevent the seal 118 from moving out of the first passageway 116 when the retainer plate 106 is attached to the bearing mount 102. The second passageway 144 is also configured to have the shaft 114 extend therethrough. As such, the lateral dimension of the second passageway 144 is at least sufficiently large to allow the shaft 114 to extend therethrough. In an embodiment, the lateral dimension of the second passageway 144 is equal or slightly larger than the lateral dimension of the shaft 114. The relatively similar lateral dimension of the second passageway 144 relative to the lateral dimension of the shaft 114 causes the retainer plate 106 to act as a secondary seal. For example, the similar lateral dimension of the second passageway 144 relative to the lateral dimension of the shaft 114 prevents or at least inhibits any material that reaches the retainer plate 106 from reaching the bearing apparatus 108. In a particular embodiment, the lateral dimension of the second passageway 144 is slightly larger (e.g., about 50 μm to about 1 mm or, more preferably 50 μm to about 500 μm) greater than the lateral dimension of the shaft 114 to prevent or minimize contact between the retainer plate 106 and the shaft 114 since such contact may at least one of increase the energy required to rotate the shaft 114, increase the heat generated while rotating the shaft 114, or increase wear on the retainer plate 106 and the shaft 114.

The retainer plate 106 is configured to be reversibly attached to the bearing mount 102 (e.g., the top plate 124). In an embodiment, as shown, the retainer plate 106 may be attached to the bearing mount 102 using the plurality of second bolts 134. In such an embodiment, the portion of the retainer plate 106 that is configured to be attached to the bearing mount 102 may define one or more third bolt holes 146 that are configured to receive the second bolts 134. Attaching the retainer plate 106 to the bearing mount 102 using the second bolts 134 allows the retainer plate 106 to be easily and reversibly attached to the bearing mount 102. For example, the retainer plate 106 may need to be detached from the bearing mount 102 when at least one of at least a portion of the bearing mount 102, the retainer plate 106, the seal 118, or the shaft 114 is repaired or replaced. Detaching the retainer plate 106 from the bearing mount 102 allows these components of the bearing seal assembly 100 to be assessed and/or removed while the bearing mount 102 supports the shaft 114 (assuming the shaft 114 is not being replaced). In an embodiment, the retainer plate 106 may be attached to the bearing mount 102 using non-bolt techniques instead of or in conjunction with the second bolts 134. Examples of such non-bolt techniques includes clamps, screws, welding, soldering, using rivets, an adhesive, or any other suitable technique.

The retainer plate 106 may also define one or more cutouts 140. The cutouts 140 of the retainer plate 106 may correspond to the cutouts 140 of the top plate 124. For example, the cutouts 140 of the retainer plate 106 may exhibit a size that is similar to and are positioned to be above the cutouts of the top plate 124 when the retainer plate 106 is attached to the top plate 124. The cutouts 140 of the retainer plate 106 perform the same function as the cutouts 140 of the top plate 124, namely facilitate attachment and detachment of the bearing mount 102 to the housing 104.

As previously discussed, the bearing seal assembly 100 includes a bearing apparatus 108. The bearing apparatus 108 includes a third passageway 147 extending at least partially therethrough. The third passageway 147 is configured to receive the shaft 114. The bearing apparatus 108 is also configured to be attached to the shaft 114 while allowing the shaft 114 to rotate relative to the housing 104. The bearing apparatus 108 may include a stator 148 and a rotor 150. The stator 148 is configured to be attached to the bearing mount 102 and does not rotate as the shaft 114 rotates. The rotor 150 is configured to be fixedly attached to the shaft 114 and is configured to rotate relative the stator 150.

The bearing apparatus 108 may include any suitable bearing apparatus 108. In an example, as illustrated, the bearing apparatus 108 is a ball bearing apparatus that include a plurality of ball bearings 152 between the stator 148 and the rotor 150. In an example, the bearing apparatus 108 may include a roller bearing apparatus, a conical bearing apparatus, a sliding bearing apparatus, a tilting pad bearing apparatus, or any other suitable bearing apparatus.

The stator 148 may include an attachment portion 154 that is configured to be reversibly attach the bearing apparatus 108 to the bearing mount 102. It is noted that the retainer plate 106 may be positioned between the stator 148 and the bearing mount 102 when the stator 148 is attached to the bearing mount 102. The attachment portion 154 may exhibit a plate-like shape which may facilitate attaching the stator 148 to the retainer plate 106 when the retainer plate 106 exhibits a plate-like structure (as shown). In an example, as shown, the attachment portion 154 may define one or more fourth bolt holes 158 that are configured to receive the second bolts 134. In an example, the attachment portion 154 is configured to be reversibly attached to the bearing mount 102 using any of the other non-bolt techniques disclosed herein. Reversibly attaching the stator 148 to the bearing mount 102 allows the stator 148 and, by extension, the bearing apparatus 108 as a whole to be detached from the bearing mount 102 when the bearing apparatus 108 or another component of the bearing seal assembly 100 needs to be repaired or replaced. The attachment portion 154 may define a portion of the third passageway 147

The stator 150 may also include a bearing portion 156 that is configured to receive the rotor 150. For example, the bearing portion 156 may define a cavity that receives the rotor 150. The bearing portion 156 may extend away from the attachment portion 154 in a direction that is parallel to a longitudinal axis of the shaft 114. Similarly, the attachment portion 154 may extend laterally away from the bearing portion 156 thereby providing a location for the fourth bolt holes 158 to be formed.

The rotor 150 may be reversibly attached to the shaft 114 using any suitable technique. Reversibly attaching the rotor 150 to the shaft 114 allows the bearing apparatus 108 to be detached from the shaft 114 when the bearing apparatus 108 is also detached from the bearing mount 102. In an example, the rotor 150 may define a screw hole 160 including threads configured to receive a screw. The screw may the insert into the screw hole 160 and rotated until the screw presses against the shaft 114 thereby securing the shaft 114 to the rotor 150. The rotor 150 may be attached to the shaft 114 using other techniques, such as a bolt extending through the rotor 150 and into the shaft 114.

As shown, the retainer plate 106 and the bearing apparatus 108 are distinct components of the bearing seal assembly 100 that may be easily separated from each other. Forming the retainer plate 106 and the bearing apparatus 108 as distinct components may increase the lifespan of the bearing apparatus 108. For example, the retainer plate 106 may act as a secondary seal that prevents the material from reaching the bearing apparatus 108 and may further space the bearing apparatus 108 from the housing 104 thereby decreasing the thermal energy from a heated material that may reach the bearing apparatus 108, both of which may increase the lifespan of the bearing apparatus 108. The retainer plate 106 may also provide a second component other than the bearing mount 102 that supports and maintains the position of the shaft 114 when the bearing apparatus 108 is replaced or repaired. That said, in an embodiment, the retainer plate 106 may be integrally formed with the bearing apparatus 108 or the retainer plate 106 may be omitted from the bearing seal assembly (e.g., the attachment portion 154 holds the seal 118 in the first passageway 116). In such an embodiment, the number of components that form the bearing seal assembly 100 is reduced thereby facilitating assembly of the bearing seal assembly 100 though some of the benefits of the retainer plate 106 may also be lost.

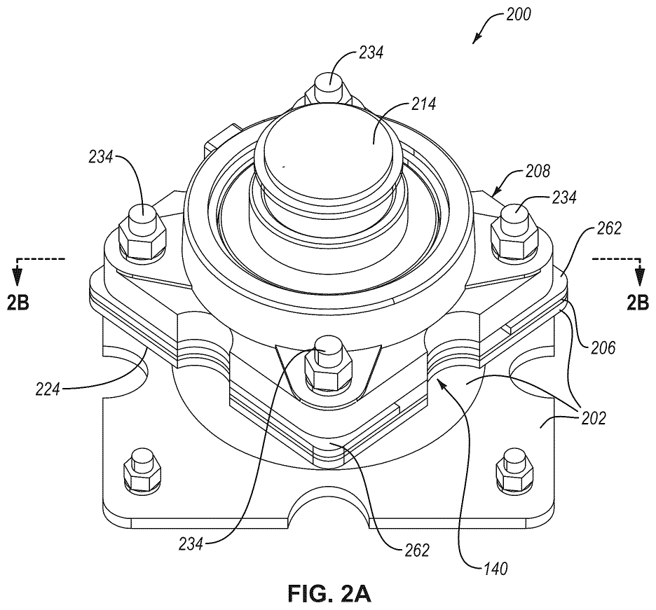

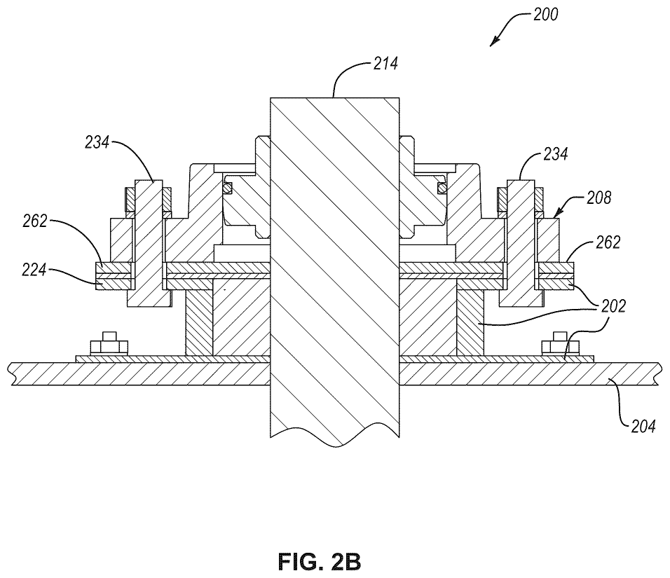

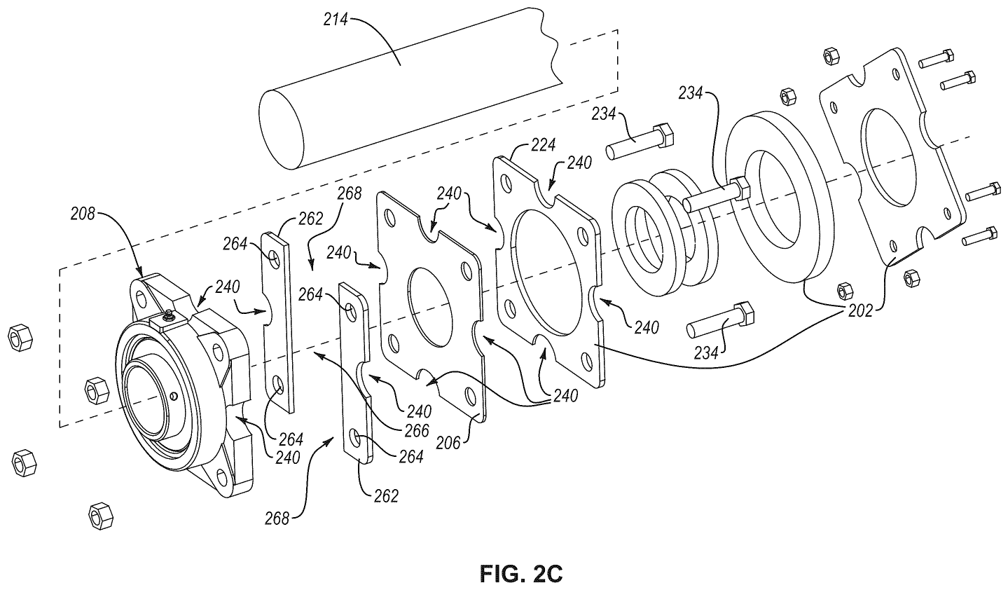

It is noted that the bearing seal assembly 100 may include one or more components other than the components illustrated in FIGS. 1A-1C. For example, FIG. 2A is an isometric view of a bearing seal assembly 200 that includes at least one apparatus spacer 262, according to an embodiment. FIG. 2B is a cross-sectional view of the bearing seal assembly 200 taken along plane 2B-2B and FIG. 2C is an exploded view of the bearing seal assembly 200. Except as otherwise disclosed herein, the bearing seal assembly 200 is the same as or substantially similar to any of the bearing seal assemblies disclosed herein. For example, the bearing seal assembly 200 includes a bearing mount 202, a retainer plate 206, and a bearing apparatus 208.

The bearing seal assembly 200 includes at least one apparatus spacer 262. The apparatus spacer 262 is positioned between the retainer plate 206 and the bearing apparatus 208 when the bearing seal assembly 200 is fully assembled. The apparatus spacer 262 is configured to space the bearing apparatus 208 further from the housing 204 than if the bearing seal assembly 200 did not include the apparatus spacer 262. Spacing the bearing apparatus 208 further from the housing 204 makes it even more difficult for any material in the interior chamber of the housing 204 to reach the bearing apparatus 208. Spacing the bearing apparatus 208 further from the hosing 204 also decreases the thermal energy from a heated material that may reach the bearing apparatus 208. The apparatus spacer 262 may also act as a heat sink that pulls thermal energy from the shaft 214 thereby further decreasing the thermal energy that reaches the bearing apparatus 208.

In an embodiment, the apparatus spacer 262 may be reversibly attached to the bearing mount 202 using the same attachment technique as the retainer plate 206 and the bearing apparatus 208. For example, the apparatus spacer 262 is attached to the bearing mount 202 using one or more second bolts 234. In such an example, the apparatus spacer 262 may define one or more fifth bolt holes 264 that are aligned with the third bolt holes 246 of the retainer plate 206 and the fourth bolt holes 258 of the bearing apparatus 208. That said, the apparatus spacer 262 may be attached using any other non-bolt techniques disclosed herein. In an embodiment, not shown, the apparatus spacer 262 may be fixedly attached (i.e., permanently attached) to the retainer plate 206 or the bearing apparatus 208 which may facilitate assembly of the bearing seal assembly 200 by decreasing the number of components of the bearing seal assembly 200. Examples of techniques that may be use to fixedly attach the apparatus spacer 262 to the retainer plate 206 or the bearing apparatus 208 includes welding and soldering.

The apparatus spacer 262 may define a fourth passageway 266 extending therethrough. The fourth passageway 266 allows the shaft 214 to extend through the apparatus spacer 262. The fourth passageway 266 may be an actual hole extending through the apparatus spacer 262 or, when the apparatus spacer 262 is formed from a plurality of pieces, by the space between the different pieces of the apparatus spacer 262. In an embodiment, the fourth passageway 266 exhibits a lateral dimension that is larger than a lateral dimension of the shaft 214. The larger lateral dimension of the fourth passageway 266 may facilitate wind flow adjacent to the shaft 214 which may pull additional thermal energy from the shaft 214 and move the thermal energy away from the shaft 214, especially when the apparatus spacer 262 defines at least one gap 268 (as will be discussed in more detail below). In an embodiment, at least a portion of the apparatus spacer 262 contacts or is positioned proximate to the shaft 214 (e.g., within about 1 mm or less, such as about 500 μm or less) which may allow the apparatus spacer 262 to better remove thermal energy from the shaft 214 via conduction.

In an embodiment, as previously discussed, the apparatus spacer 262 may define a gap 268. The gap 268 may extend laterally from the fourth passageway 266 to an outer edge of the apparatus spacer 262. The gap 268 forms a path from an exterior of the bearing seal assembly 200 to the fourth passageway 266. The gap 268 may allow air flow from an exterior of the bearing seal assembly 200 to the shaft 214. Such air flow may facilitate cooling of the shaft 214. The air flow may also remove any material that has moved along the shaft 214 that is present in the fourth passageway 266 such that the material does not reach the bearing apparatus 208. In a particular embodiment, the gap 268 may be located gravimetrically below the shaft 214 (e.g., when the bearing seal assembly 100 is assembled and attached to the housing 204). Locating the gap 268 below the shaft 214 allows at least some of the material on the shaft 214 to fall off the shaft 214 and out of the bearing seal assembly 200 through the gap 268 due to gravity.

The gap 268 may be formed using any suitable technique. In an embodiment, as shown, the apparatus spacer 262 is formed from two or more pieces. In such an embodiment, the fourth passageway 266 and the gap 268 may be formed by spacing the two or more pieces of the apparatus spacers 262 from each other. It is noted that the two or more pieces that form the apparatus spacers 262 may form a plurality of gaps 268. One of the plurality of gaps 268 may be located gravimetrically below the shaft 214 while one or more of the remaining gaps 268 may not be located gravimetrically below the shaft 214 (e.g., above the shaft 214). The gap 268 below the shaft 214 may facilitate removal of the material from the shaft 214 as previously discussed while the other gap(s) 268 may facilitate a cross-breeze through the fourth passageway 266 which may further facilitate removal of the material and thermal energy from the shaft 214. In an embodiment, the apparatus spacer 262 is formed from a single piece. In such an example, the apparatus spacer 262 may exhibit a generally U-like cross-sectional shape. Examples of apparatus spacers 262 exhibiting a generally U-like cross-sectional shape include a plate or cylinder defining a cutout extending from an edge thereof to the fourth passageway 266. In an embodiment, the apparatus spacers 262 does not define a gap. In such an embodiment, the apparatus spacer 262 may be a hollow plate or cylindrical structure.

The apparatus spacer 262 may also define one or more cutouts 240. The cutouts 240 of the apparatus spacer 262 may correspond to the cutouts 240 of the top plate 224 of the bearing mount 202, the retainer plate 206, and the bearing apparatus 208. For example, the cutouts 240 of the apparatus spacer 262 may exhibit a size that is similar to and are positioned to be above the cutouts 240 of the top plate 224 and the retainer plate 206. The cutouts 240 of the apparatus spacer 262 perform the same function as the cutouts of the top plate 224, the retainer plate 206, and the bearing apparatus 208, namely facilitate attachment and detachment of the bearing mount 202 to the housing 204.

It is noted that the bearing seal assemblies disclosed herein may include one or more structures other than the structures disclosed above. For example, the bearing seal assemblies disclosed herein may include a seal between adjacent structural elements, such as a seal between the housing and the bottom plate of the bearing mount, the top plate of the bearing mount and the retainer plate, the retainer plate and one of the bearing apparatus or the apparatus spacer, or the apparatus spacer and the bearing apparatus. Such seals may limit heat flow between the structures of the bearing seal assembly and dampen any vibrations in the bearing seal assembly. In an example, the bearing seal assembly may include one or more sensors that detect one or more characteristics of the bearing seal assembly, such as the temperature of one or more components of the bearing seal assembly or vibrations in the bearing seal assembly.

It is also noted that one or more of the structures disclosed above may be omitted from the bearing seal assemblies disclosed herein. For example, the retainer plate may be omitted. In such an example, the bearing apparatus or the apparatus spacer may be used to maintain the seal in the first passageway. In an example, the seal may be omitted, for example when the bottom plate of the bearing mount and/or the retainer plate form a good enough seal by themselves to prevent or at least inhibit the material from flowing along the shaft, such as when the material is relatively course.

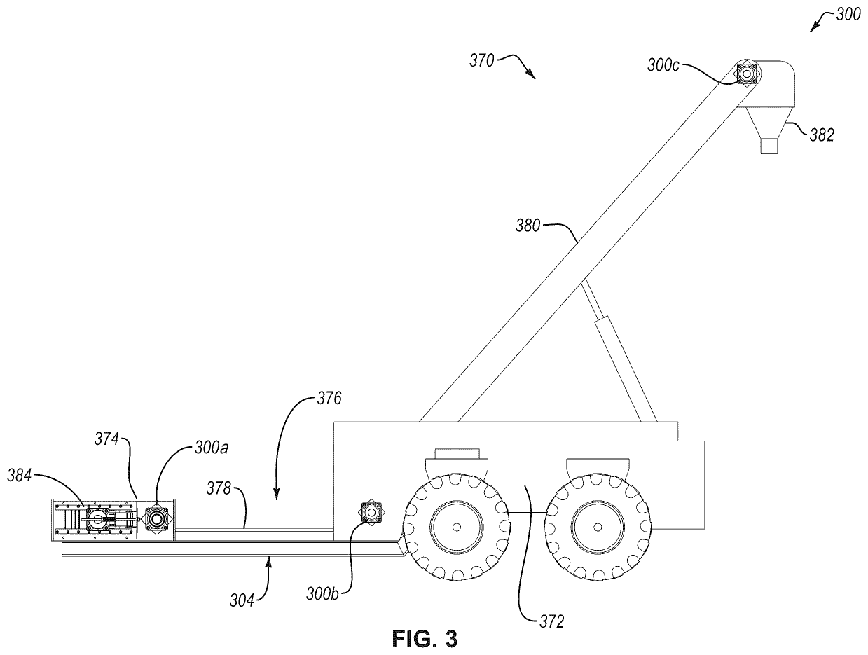

As previously discussed, the bearing seal assemblies disclosed herein may formed part of a larger system. In a particular embodiment, the bearing seal assemblies disclosed herein may be used in a bulk material conveyor system, such as a closed bulk material conveyor system. However, as previously discussed, the bearing seal assemblies disclosed herein may be used in other systems. FIG. 3 is an isometric view of the closed bulk material conveyor system 370 that includes one or more bearing seal assemblies, according to an embodiment. Except as otherwise disclosed herein, the one or more bearing seal assemblies (e.g., the first bearing seal assembly 300a, the second bearing seal assembly 300b, and/or the third bearing seal assembly 300c) may be the same as or substantially similar to any of the bearing seal assemblies disclosed herein.

The conveyor system 370 includes a housing 304 defining an interior region. The housing 304 may include a forward section 372, the back section 374 opposite the forward section 372, and an inlet for 376 between the forward section 372 and the back section 374. The conveyor system 370 includes a conveyor belt 378 that extends from the forward section 372, across the inlet 376, and to the back section 374. As such, the conveyor system 370 may receive a bulk material (e.g., sand, fertilizer, corn, or salt) at the inlet 376 and the conveyor belt 378 can move the bulk material from the inlet 376 to the forward section 372. The housing 304 may also include a chute 380 defining an outlet 382. The conveyor system 370 may be configured to move the bulk material that is received in forward section 372 up the chute 380 and out the outlet 382. For example, the conveyor belt 378 or a separate conveyor belt (not shown) may extend along the chute 380 thereby allowing the bulk material received in the forward section 372 to move up the chute 380 and out the outlet 382.

The particular arrangement of the conveyor system 370 shown in FIG. 3 may allow the bulk material to be dispensed from a first container (e.g., a covered hopper rail car, gondola rail car, open hopper rail car, end dump trailer, side dump trailer, bottom dump trailer, stationary hopper, etc.) into the inlet 376, for instance, using gravity. The conveyor system 370 then moves the bulk material to a second container that is different from and, optionally, spaced from the first container.

The bearing seal assemblies may be located at any external location on the housing 304. The one or more bearing seal assemblies may also include any suitable number of bearing seal assemblies. For example, as shown, the one or more bearing seal assemblies may include a first bearing seal assembly 300a, a second bearing seal assembly 300b, and a third bearing seal assembly 300c. The first bearing seal assembly 300a may be located in the back section 374 of the housing 304 and may facilitate changing the direction that the conveyor belt 378 that extends into the back section 374. The second bearing seal assembly 300b may be located in the forward section 372 may facilitate bending the conveyor belt 378 between the forward section 372 and the chute 380. The third bearing seal assembly 300c may be located in the chute 380 and may facilitate changing the direction that the conveyor belt 378 that extends into the chute 380 near the outlet 382. It is also noted that the conveyor system 370 may include more or fewer bearing seal assemblies than what is illustrated in FIG. 3.

FIG. 3 merely illustrates one side of the conveyor system 370. In an embodiment, the opposing side of the conveyor system 370 includes additional bearing seal assemblies (not shown) corresponding to one or more of the first bearing seal assembly 300a, the second bearing seal assembly 300b, or the third bearing seal assembly 300c. The bearing seal assemblies may be the same as any of the bearing seal assemblies disclosed herein. The additional bearing seal assemblies are rotatably attached to the opposing side of shafts and, thus, the bearing seal assemblies 300a, 300b, 300c and the additional bearing seal assemblies provide support to both sides of the shaft. The additional bearing seal assemblies may also be configured to prevent the bulk material from reaching the bearing apparatus thereof.

The conveyor system 370 may include bearing assemblies and bearing apparatuses other than the bearing seal assemblies disclosed herein. For example, the conveyor system 370 may include an external bearing apparatus 384. The external bearing apparatus 384 is configured to adjust the tension in the conveyor belt 378 while also preventing the bulk material from reaching the bearing apparatus thereof. Examples of such an external bearing apparatus is disclosed in U.S. Provisional Patent Application No. 63/491,842 filed on May 31, 2023, the disclosure of which is incorporated herein, in its entirety, by this reference.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, or ±2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

What is claimed is:

1. A bearing seal assembly, comprising:
a bearing mount including a bottom plate, a top plate, and a bearing mount spacer positioned between the bottom plate and the top plate, the bottom plate attached to the bearing mount spacer and the bearing mount spacer attached to the top plate, the bearing mount defining a first passageway extending therethrough;
at least one seal configured to be positioned in the first passageway;
a retainer plate configured to be positioned adjacent to the top plate of the bearing mount, the retainer plate configured to maintain the at least one seal in the first passageway, the retainer plate defining a second passageway extending therethrough; and
a bearing apparatus configured to be positioned adjacent to the retainer plate;
wherein the first passageway, the second passageway, and the bearing assembly are configured to receive a shaft.

2. The bearing seal assembly of claim 1, wherein the bottom plate defines a first portion of the first passageway, the bearing mount spacer defines a second portion of the first passageway, and the top plate defines a third portion of the first passageway, and wherein the first portion exhibits a lateral dimension that is smaller than a corresponding lateral dimension of the second portion and the third portion.

3. The bearing seal assembly of claim 2, wherein the second portion and the third portion exhibit a size that is sufficient to receive the at least one seal and the shaft, the first portion exhibiting a size that prevents the at least one seal from being positioned in the first portion.

4. The bearing seal assembly of claim 1, wherein the bottom plate is welded to the bearing mount spacer and the bearing mount spacer is welded to the top plate.

5. The bearing seal assembly of claim 1, wherein the top plate includes one or more portions that are not positioned directly above the bottom plate.

6. The bearing seal assembly of claim 5, wherein both the top plate and the bottom plate exhibit a generally rectangular shape or a generally square shape and the top plate is rotated 45° relative to the bottom plate.

7. The bearing seal assembly of claim 1, wherein the bottom plate defines one or more cutouts and one or more portions of the top plate that are attached to the retainer plate are positioned above the one or more cutouts.

8. The bearing seal assembly of claim 1, wherein the top plate defines one or more cutouts and one or more portions of the bottom plate that are attached to a housing are positioned below the one or more cutouts.

9. The bearing seal assembly of claim 8, wherein the retainer plate defines one or more cutouts that correspond to the one or more cutouts defined by the top plate.

10. The bearing seal assembly of claim 8, wherein the bearing apparatus defines one or more cutouts that correspond to the one or more cutouts defined by the top plate.

11. The bearing seal assembly of claim 1, wherein the top plate and the bottom plate extend outwardly from the bearing mount spacer.

12. The bearing seal assembly of claim 1, wherein the at least one seal includes at least one felt seal.

13. The bearing seal assembly of claim 1, wherein the at least one seal includes two felt seals.

14. The bearing seal assembly of claim 1, wherein the retainer plate is reversibly attached to the bearing mount using a plurality of bolts.

15. The bearing seal assembly of claim 1, wherein the bearing apparatus is reversibly attached to the retainer plate using a plurality of bolts.

16. The bearing seal assembly of claim 1, further comprising one or more apparatus spacers positioned between the retainer plate and the bearing apparatus, the one or more apparatus spacers defining a third passageway extending therethrough.

17. The bearing seal assembly of claim 16, wherein the one or more apparatus spacers include two apparatus spacers.

18. The bearing seal assembly of claim 17, wherein the one or more apparatus spacers define at least one gap extending from a lateral edge of the one or more apparatus spacers to the third passageway.

19. The bearing seal assembly of claim 1, further comprising a shaft extending through at least the first passageway and the second passageway and attached to the bearing apparatus, and
wherein the retainer plate and the bearing apparatus are attached to the bearing mount.

20. The bearing seal assembly of claim 1, further comprising one or more apparatus spacers positioned between the retainer plate and the bearing apparatus, the one or more apparatus spacers defining a third passageway extending therethrough and the shaft extending through the third passageway, the one or more apparatus spacers define at least one gap extending from a lateral edge of the one or more apparatus spacers to the third passageway, the at least one gap positioned gravimetrically below the shaft.

21. A conveyor system, comprising:
a housing defining an interior region and at least one inlet configured to allow a material to enter the interior region;
a conveyor belt at least partially positioned in the interior region;
a shaft partially positioned in the interior region, the conveyor belt positioned around a portion of the shaft; and
at least one bearing seal assembly attached to an exterior of the housing, the at least one bearing seal assembly comprising:
a bearing mount including a bottom plate, a top plate, and a bearing mount spacer positioned between the bottom plate and the top plate, the bottom plate attached to the bearing mount spacer and the bearing mount spacer attached to the top plate, the bearing mount defining a first passageway extending therethrough;
at least one seal positioned in the first passageway;
a retainer plate positioned adjacent to the top plate of the bearing mount, the retainer plate configured to maintain the at least one seal in the first passageway, the retainer plate defining a second passageway extending therethrough; and
a bearing apparatus positioned adjacent to the retainer plate;
wherein the first passageway, the second passageway, and the bearing assembly receive the shaft.

22. A method of using a bearing seal assembly, the method comprising:
rotating a shaft extending through a first passageway of a bearing mount, a second passageway of a retainer plate, and attached to a bearing apparatus;
wherein:
the bearing mount includes a bottom plate, a top plate, and a bearing mount spacer positioned between the bottom plate and the top plate, the bottom plate attached to the bearing mount spacer and the bearing mount spacer attached to the top plate, the bearing mount defining the first passageway extending therethrough;
at least one seal configured to be positioned in the first passageway;
the retainer plate positioned adjacent to the top plate of the bearing mount, the retainer plate configured to maintain the at least one seal in the first passageway, the retainer plate defining the second passageway extending therethrough; and
the bearing apparatus positioned adjacent to the retainer plate.

23. A method to repair a bearing seal assembly, the method comprising:
detaching a bearing apparatus from a retainer plate and a bearing mount; and
repairing or replacing one or more components of the bearing seal assembly;
wherein:
the bearing mount includes a bottom plate, a top plate, and a bearing mount spacer positioned between the bottom plate and the top plate, the bottom plate attached to the bearing mount spacer and the bearing mount spacer attached to the top plate, the bearing mount defining a first passageway extending therethrough;
at least one seal configured to be positioned in the first passageway;
the retainer plate positioned adjacent to the top plate of the bearing mount, the retainer plate configured to maintain the at least one seal in the first passageway, the retainer plate defining a second passageway extending therethrough; and
the bearing apparatus positioned adjacent to the retainer plate before detaching the bearing apparatus from the retainer plate and the bearing mount.

24. The method of claim 23, further comprising detaching the retainer plate from the bearing mount.
